(19) United States
(12) Patent Application Publication
(10) Pub. No.: US 2007/0032932 A1
(43) Pub. Date: Feb. 8, 2007

(54) Method and apparatus for providing a visual indication of a position of a steerable wheel, and components thereof

(76) Inventors: Chin Heong Yeoh, Bukit Mertajam (MY); Chiang Sun Cheah, Penang (MY); Li Chong Tai, Penang (MY)

Correspondence Address: AVAGO TECHNOLOGIES, LTD., P.O. BOX 1920, DENVER, CO, 80201-1920, US

(21) Appl. No.: 11/198,421

(22) Filed: Aug. 5, 2005

(51) Int. Cl. B62D 6/00; G06F 17/00

(52) U.S. Cl. 701/41; 701/1

(57) ABSTRACT

In one embodiment, apparatus for providing a visual indication of a position of a steerable wheel includes an encoder and a display system. The encoder has a mechanism for mounting part of the encoder to a movable component of a steering system coupled to the steerable wheel. The encoder produces an output signal related to a position of the movable component. The display system is responsive to the output signal produced by the encoder and displays the visual indication of the position of the steerable wheel. Other embodiments are also disclosed.

### BACKGROUND

One way in which automobile manufacturers entice people to buy their automobiles is by providing their automobiles with various controls, indicators and gadgets that drivers may find useful or nifty. For example, an automobile cockpit may be provided with various fluid gauges, light indicators, trip meters, indoor/outdoor temperature gauges, door position indicators, stereo controls, heating/cooling controls, a GPS system, and so on. Depending on the class of drivers to which an automobile is to be marketed, the automobile may be provided with different combinations of these and other controls, indicators and gadgets. Automobile manufacturers that can offer new and different controls, indicators and gadgets can sometimes achieve a competitive advantage over other automobile manufacturers.

### SUMMARY OF THE INVENTION

In a first embodiment, apparatus for providing a visual indication of a position of a steerable wheel comprises an encoder and a display system. The encoder has a mechanism for mounting part of the encoder to a movable component of a steering system coupled to the steerable wheel. The encoder produces an output signal related to a position of the movable component. The display system is responsive to the output signal produced by the encoder and displays the visual indication of the position of the steerable wheel.

In a second embodiment, a system for providing a visual indication of a position of a steerable wheel comprises a movable component of a steering system for steering the steerable wheel, an encoder, and a display system. The encoder is operatively associated with the movable component and produces an output signal related to a position of the moveable component. The display system is responsive to the output signal produced by the encoder and displays the visual indication of the position of the steerable wheel.

In a third embodiment, a method for providing a visual indication of a position of a steerable wheel comprises: 1) encoding a position of a movable component of a steering system connected to the steerable wheel; 2) decoding the encoded position of the movable component; 3) correlating the decoded position of the moveable component with a position of the steerable wheel; and 4) displaying the visual indication of the position of the steerable wheel.

In a fourth embodiment, a movable component of a steering system comprises a reflective code pattern applied to the movable component.

Other embodiments are also disclosed.

### BRIEF DESCRIPTION OF THE DRAWINGS

Illustrative and presently preferred embodiments of the invention are illustrated in the drawings, in which:

FIG. 1 illustrates an exemplary method for providing a visual indication of the position of a steerable wheel;

FIGS. 2-5 illustrate exemplary systems in which the method shown in FIG. 1 may be implemented; and

FIGS. 6 & 7 illustrate an exemplary embodiment of the display shown in FIGS. 2-5.

### DETAILED DESCRIPTION

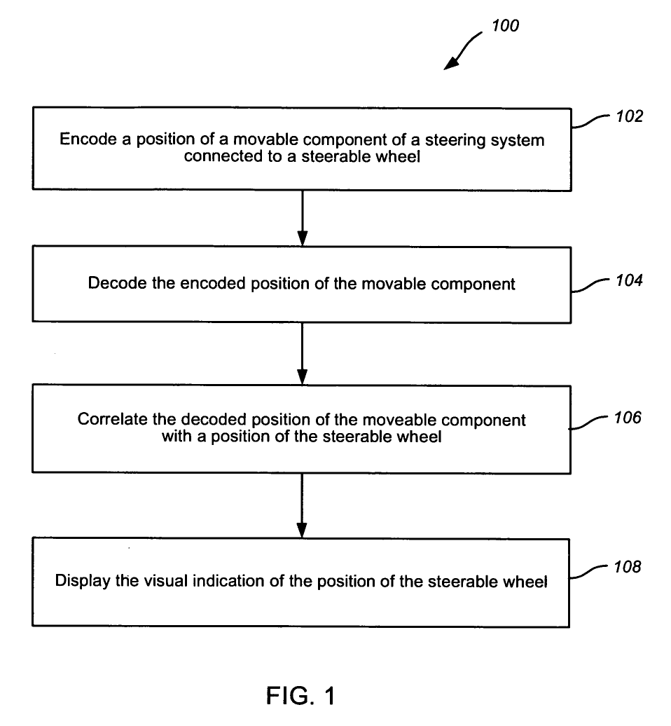

An indicator that a driver may find useful (or at least nifty) is a wheel position indicator (e.g., an indicator that lets the driver know whether their vehicle's wheels are oriented left or right, and to what degree). FIG. 1 therefore illustrates an exemplary method 100 for providing a visual indication of the position of a steerable wheel (or wheels). The method 100 comprises encoding 102 the position of a movable component of a steering system that is connected to the steerable wheel. The encoded position of the movable component is then decoded 104 and correlated 106 with a position of the steerable wheel. A visual indication of the position of the steerable wheel is then displayed 108.

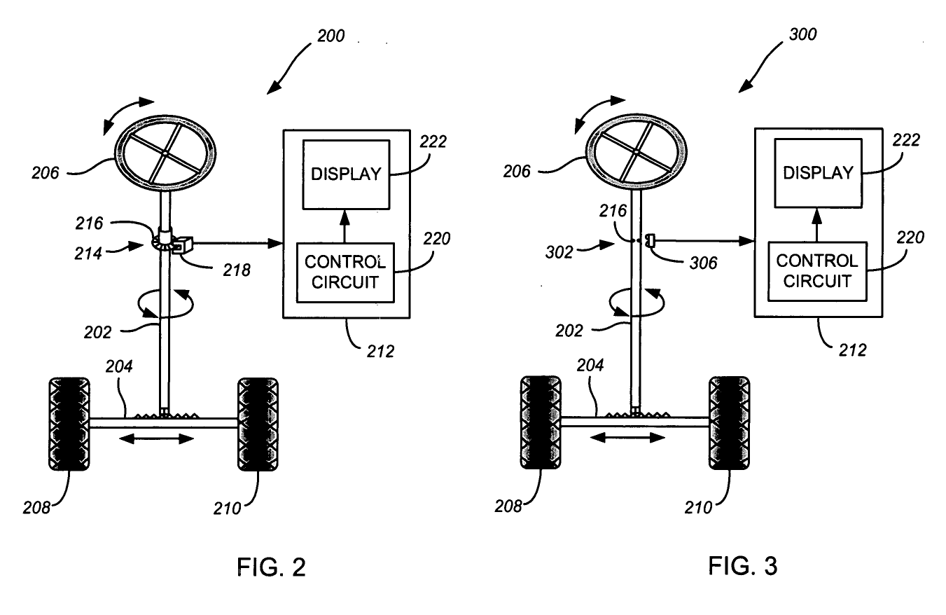

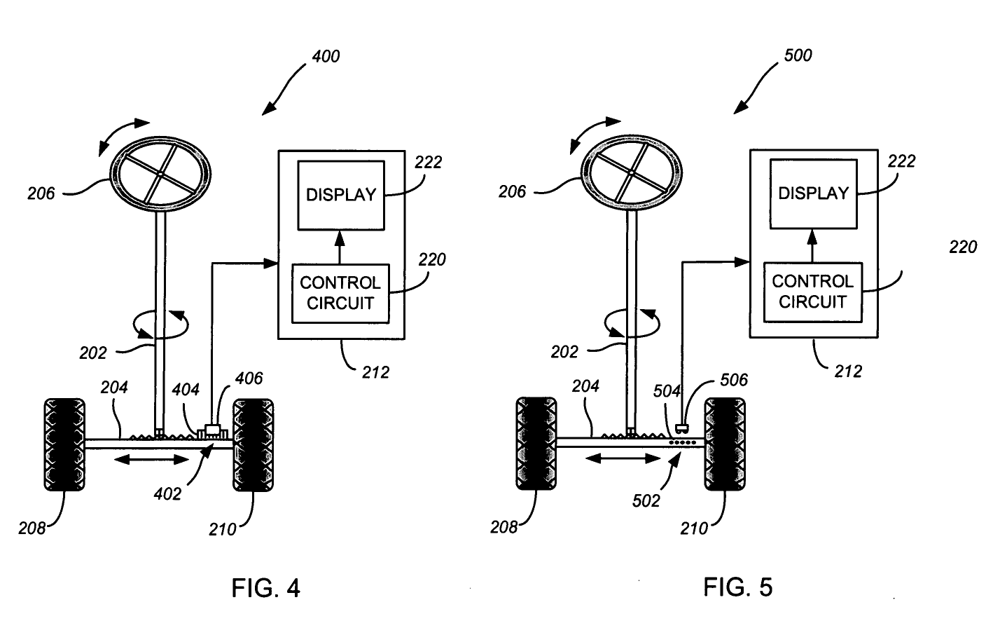

FIGS. 2-5 illustrate exemplary systems 200, 300, 400, 500 in which the method 100 may be implemented. By way of example, the moveable components of each system 200, 300, 400, 500 comprise a steering column 202 and a steering rack 204. The steering column 202 is coupled to a steering wheel 206, and the steering rack 204 is coupled to one or more wheels 208, 210 (possibly through connecting elements such as tie rods). By way of example, the steering rack may be a purely mechanical steering rack or a hydraulic steering rack (e.g., a power steering rack).

As is customary in many steering systems, the steering wheel 206 imparts a rotation to the steering column 202, and the steering column 202 causes a translation of the steering rack 204. Translation of the steering rack 204 then causes the wheels 208, 210 to which the steering rack 204 is coupled to move between left-facing and right-facing positions.

In each of the systems 200, 300, 400, 500, an encoder is operatively associated with a movable component of the system so as to produce output signals that are related to the position of the movable component. These output signals are then provided to a display system 212 that displays a visual indication of the position of the system's wheels 208, 210.

In the system 200, an encoder 214 comprises a code wheel 216 that is coupled to the system's steering column 202. The code wheel 216 may be coupled or mounted to the steering column 202 using various mechanisms, such as a clasp, an adhesive-backing, solder or a set screw. Depending on the mounting position of the code wheel 216, and the conditions to which it will be exposed, the code wheel 216 may be made of various materials, such as metal or plastic. Also, and depending on the extent to which the steering column 202 can be rotated, the code wheel 216 may be a full code wheel or a partial code wheel (e.g., half or two-thirds of a code wheel). For purposes of this description, both full code wheels and partial code wheels will be generally referred to as “code wheels”.

In one embodiment, the encoder 214 may be an analog encoder that produces an analog output signal determined by a resistance that varies with the position of the code wheel 216. In another embodiment, the encoder 214 may be a digital encoder, such as an optical encoder.

If the encoder 214 is an optical encoder, the code wheel 216 may comprise a pattern of windows through which a light source of the optical encoder is shone. A detector of the optical encoder may then receive the “code” projected through the code wheel 216 as a result of movement of the code wheel 216. In an alternate embodiment, the code wheel 216 may have a reflective code pattern thereon, and the encoder may reflect light from a light source to a detector via the code wheel 216. In either case, the encoder detects light that is transmitted through, or reflected from, the code wheel 216. This detected light is then converted to an output signal related to the position of the steering column 202.

In the case of a transmissive optical encoder, an opposed light source and detector set 218 for projecting light through (and detecting light from) the code wheel 216 can be mounted to a fixed sheath of the steering column 202, or to a fixed support adjacent the steering column 202. In the case of a reflective encoder, a single unit that provides both a light source and a detector may be mounted to a fixed sheath of the steering column 202, or to a fixed support adjacent the steering column 202.

Preferably, the encoder 214 is an absolute encoder. For example, if the encoder 214 is an optical encoder, the encoder 214 may comprise a code wheel having a series of concentric windows or reflective patterns. In this manner, a single detection cycle can be used to determine the position of the steering column 202. If the encoder 214 is not an absolute encoder, the display system 212 needs to be initialized at some point, and may need to comprise nonvolatile memory to store and increment/decrement a perpetual count of detected windows or reflective dots. Otherwise, the display system 212 may lose track of a vehicle's wheel position.

In the system 300, an optical encoder 302 comprises a reflective code pattern 304 applied in a ring about a circumference of the steering column 202. A single unit 306 that provides both a light source and a detector may be mounted to a fixed sheath of the steering column 202, or to a fixed support adjacent the steering column 202. The system 300 may be advantageous in some cases in that it reduces system part count.

In the system 400, an encoder 402 comprises a code strip 404 coupled or mounted to the system's steering rack 204. The code strip 404 may be coupled to the steering rack 204 using various mechanisms, such as a clasp, an adhesive-backing, solder or a set screw. Depending on the mounting position of the code strip 404, and the conditions to which it will be exposed, the code strip 404 may be made of various materials, such as metal or plastic.

In one embodiment, the encoder 402 may be an analog encoder that produces an analog output signal determined by a resistance that varies with the position of the code strip 404. In another embodiment, the encoder 402 may be a digital encoder, such as an optical encoder.

If the encoder 402 is an optical encoder, the code strip 404 may comprise a pattern of windows through which a light source of the optical encoder 402 is shone. A detector of the optical encoder then receives the “code” projected through the code strip as a result of movement of the code strip 404. In an alternate embodiment, the code strip 404 may have a reflective code pattern thereon, and the optical encoder 402 may reflect light from a light source to a detector via the code strip 404. In either case, the encoder detects light that is transmitted through, or reflected from, the code strip 404. This detected light is then converted to an output signal related to the position of the steering rack 204.

In the case of a transmissive optical encoder, an opposed light source and detector set 406 for projecting light through (and detecting light from) the code strip 404 can be mounted to a fixed support adjacent the steering rack 204. In the case of a reflective encoder, a single unit that provides both a light source and a detector may be mounted to a fixed support adjacent the steering rack 204.

Preferably, the encoder 402 is an absolute encoder. For example, if the encoder 402 is an optical encoder, the encoder 402 may comprise a code strip 404 having rows of windows or reflective patterns. In this manner, a single detection cycle can be used to determine the position of the steering rack 204.

In the system 500, an optical encoder 502 comprises a reflective code pattern 504 applied in a line extending along a major axis of the steering rack 204. A single unit 506 that provides both a light source and a detector may be mounted to a fixed support adjacent the steering rack 204. The system 500 may be advantageous in some cases in that it reduces system part count.

In steering systems comprising other movable components and linkages, an encoder may be associated with moveable components that are not shown in FIGS. 2-5. For example, in a recirculating ball steering system, the encoder could be associated with a steering column or movable steering rod (or arm).

The display system 212 provided for the systems 200, 300, 400, 500 may take various forms. Typically, it will comprise at least a display 220, and control circuitry 222 to interpret the output signal of an encoder and generate appropriate drive signals for the display 220 (see FIG. 2). In some cases, the display may be analog (e.g., a pair or series of indicator lamps), and in other cases, the display may be digital (e.g., a liquid crystal display (LCD)).

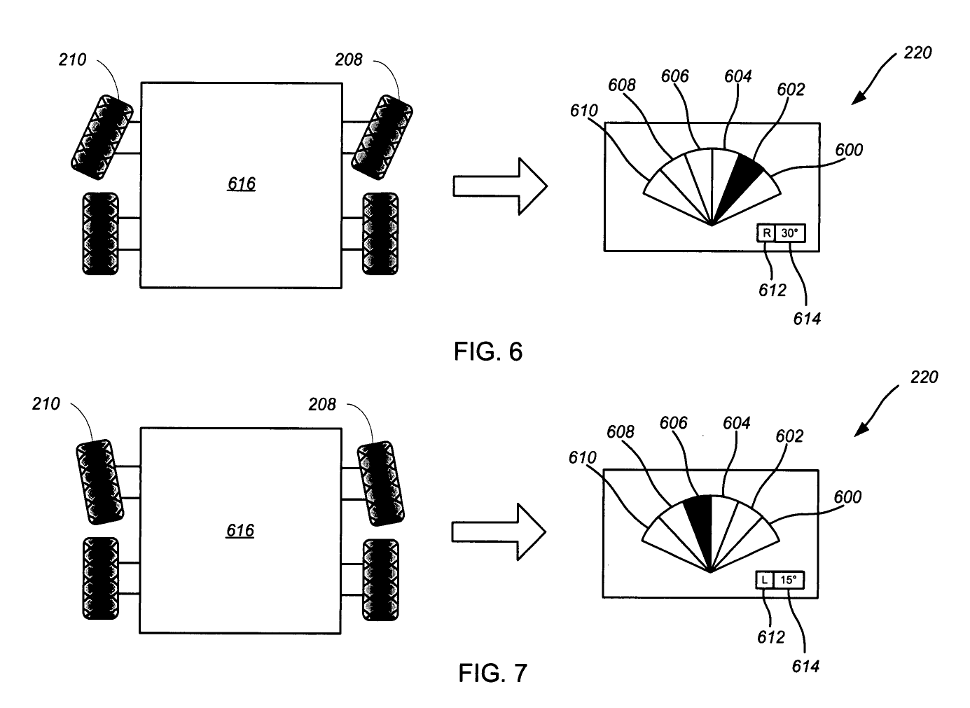

In one embodiment, the display 220 comprises a plurality of segments 600, 602, 604, 606, 608, 610 (such as pie-shaped segments; see FIG. 6), predetermined ones of which are lit in response to the output signal produced by an encoder. The lit segments indicate the position of one or more steerable wheels 208, 210. For example, and as shown in FIG. 6, when a vehicle's wheels 208, 210 (e.g., on vehicle 616) are turned to the right, the segment 602 may be lit. Additionally, or alternately, indicators 612, 614 may indicate that the wheels 208, 210 are turned to the right (R), and to what degree (e.g., 300). As shown in FIG. 7, when a vehicle's wheels 208, 210 are turned to the left, the segment 606 may be lit, and the indicators 612, 614 may indicate that the wheels 208, 210 are turned to the left (L) by 150.

In other embodiments, the display 220 may comprise more or less sophisticated elements.

Although the above-described systems, and variants thereof, may be incorporated into any system or vehicle comprising a steerable wheel, they are believed to be especially useful in automobiles and trucks. The apparatus and systems described herein may be especially useful, for example, when a driver first enters their vehicle and is unsure which direction their steerable wheels are facing. The disclosed apparatus and systems may also be useful when a driver is maneuvering to parallel-park along a curb. For new or elderly drivers, the disclosed apparatus and systems may improve driver confidence and judgment.

What is claimed is:

1. Apparatus for providing a visual indication of a position of a steerable wheel, comprising:
an encoder having a mechanism for mounting part of the encoder to a movable component of a steering system coupled to the steerable wheel, the encoder producing an output signal related to a position of the movable component; and
a display system, responsive to the output signal produced by the encoder, to display the visual indication of the position of the steerable wheel.

2. The apparatus of claim 1, wherein the mechanism for mounting part of the encoder to the movable component comprises a clasp attached to a code member of the encoder.

3. The apparatus of claim 1, wherein the mechanism for mounting part of the encoder to the movable component comprises an adhesive-backing on a code member of the encoder.

4. The apparatus of claim 1, wherein the encoder is an absolute encoder.

5. The apparatus of claim 1, wherein the display system comprises a plurality of segments, predetermined ones of which are lit in response to the output signal produced by the encoder, the lit segments indicating the position of the steerable wheel.

6. A system for providing a visual indication of a position of a steerable wheel, comprising:
a movable component of a steering system for steering the steerable wheel;
an encoder, operatively associated with the movable component, producing an output signal related to a position of the moveable component; and
a display system, responsive to the output signal produced by the encoder, to display the visual indication of the position of the steerable wheel.

7. The system of claim 6, wherein:
the movable component is a steering column; and
the encoder comprises a code wheel, coupled to the steering column.

8. The system of claim 6, wherein:
the movable component is a steering rack; and
the encoder comprises a code strip, coupled to the steering rack.

9. The system of claim 6, wherein the encoder is an absolute encoder.

10. The system of claim 6, wherein the display system comprises a plurality of segments, predetermined ones of which are lit in response to the output signal produced by the encoder, the lit segments indicating the position of the steerable wheel.

11. The system of claim 6, wherein:
the encoder is an optical encoder;
the movable component is a steering column; and
the optical encoder comprises a reflective code pattern applied in a ring about a circumference of the steering column.

12. The system of claim 6, wherein:
the encoder is an optical encoder;
the movable component is a steering rack; and
the optical encoder comprises a reflective code pattern applied in a line extending along a major axis of the steering rack.

13. A method for providing a visual indication of a position of a steerable wheel, comprising:
encoding a position of a movable component of a steering system connected to the steerable wheel;
decoding the encoded position of the movable component;
correlating the decoded position of the moveable component with a position of the steerable wheel; and
displaying the visual indication of the position of the steerable wheel.

14. The method of claim 13, wherein encoding the position of the movable component of the steering system comprises encoding the position of a steering column.

15. The method of claim 13, wherein encoding the position of the movable component of the steering system comprises encoding the position of a steering rack.

16. The method of claim 13, wherein providing the visual indication of the position of the steerable wheel comprises illuminating a predetermined portion of a display.

17. A movable component of a steering system, comprising:
a reflective code pattern applied to the movable component.

18. The movable component of claim 17, wherein:
the movable component is a steering column; and
the reflective code pattern is applied in a ring about a circumference of the steering column.

19. The movable component of claim 17, wherein:
the movable component is a steering rack; and
the reflective code pattern is applied in a line extending along a major axis of the steering rack.
